(19) United States
(12) Patent Application Publication
(10) Pub. No.: US 2014/0164276 A1
(43) Pub. Date: Jun. 12, 2014

(54) Pledging Systems and Methods

(71) Applicant: Sciberus, Inc., Decatur, GA (US)

(72) Inventor: Laron Andrion Walker, Decatur, GA (US)

(73) Assignee: Sciberus, Inc., Decatur, GA (US)

(21) Appl. No.: 14/101,315

(22) Filed: Dec. 9, 2013

Related U.S. Application Data
(60) Provisional application No. 61/734,965, filed on Dec. 8, 2012.

(51) Int. Cl. G06Q 30/02

(52) U.S. Cl. CPC G06Q 30/0279
USPC 705/329

(57) ABSTRACT

The present disclosure provides a system comprising a controller and a memory that stores program instructions executable by the controller. By executing the program instructions, the controller displays a plurality of pledge options including an associated task, wherein each associated task includes an assigned score. The controller also receives a selection of at least one pledge option, a pledge value associated with the pledge option, and user information from each a plurality of users, and to communicate the pledge option, the pledge value, and the user information to an entity associated with the pledge. Upon confirmation of a user completing the associated task, the controller generates a user score based on the sum of all the assigned scores of the associated tasks completed by the user. The controller also provides a dashboard displaying the user score for each of the plurality of users.

### CROSS-REFERENCE TO RELATED APPLICATIONS

This application incorporates by reference and claims priority to U.S. Provisional Application 61/734,965 filed on Dec. 8, 2012.

### BACKGROUND OF THE INVENTION

The present subject matter relates generally to pledging systems and methods.

Many charitable organizations fail to take advantage of their full market potential due to the inconvenience associated with the donating process. For example, may systems require a user to log onto a certain webpage, enter various user information, submit credit card numbers, the user's address, etc. In other words, the systems and methods are inconvenient and a hassle to people who wish to donate, so much so, that many users decide to forgo contributing due to the cumbersome process. Moreover, many pledging systems have monetary caps associated with collecting funds through a mobile phone service provider (i.e., the caps are mandated by the service provider, not the pledging system or the charitable organization).

In addition, charity organizations as well as other organizations often would benefit from analyzing information associated with various contributions. For example, an employer organization may want to analyze the contributions from its employees with respect to the various charitable organizations to see which charitable organization its employees contributed to the most. Currently, in order to provide analysis, each person that contributed would need to manually enter his or her user information. Thus, many organizations forgo collecting the information from their contributors in order to streamline the collecting process, and as a result, forfeit the analysis that could be provided had the user information been obtained.

In addition, many conventional pledging systems only allow for monetary contributions. This is a significant limitation, as many charitable organizations accept and would benefit from tracking non-monetary contributions, including contributions of service time and goods.

As such, there is a need for a pledging system and method that incorporates a convenient mechanism to collect pledges and associated user information, wherein the pledges may be both monetary and non-monetary. The system should also provide effective analysis of the contributions without burdening the pledging parties and organizations.

### BRIEF SUMMARY OF THE INVENTION

The present disclosure provides a system for accepting and tracking pledge contributions. Various examples of the systems and methods are provided herein.

The present systems and methods provide organizations with an efficient and effective way to collect and analyze both monetary and non-monetary pledges from a user. Primary embodiments of the systems and methods are directed to text-based pledges (i.e., pledges via text message), though many of the advantages described herein may be accomplished through mobile applications, web-based applications, and the like, as will be understood by those skilled in the art based on the present disclosure.

In a typical process flow, the system provides an organization with user information upon a user submitting a pledge, such that the organization may track and analyze user demographic information associated with the received pledges. In addition, the collection of funds may be processed separately via email, automated phone payment systems, or outsourced contact center services. As a result, the present system can eliminate the monetary caps typically placed on text-based donations due to being billed billed directly through a mobile phone service provider.

Particularly unique to the present system and method is providing a pledge system that enables users to pledge time, service, and objects, among other non-monetary contributions, in addition to monetary contributions. In addition, the present system may provide a user score, such as a “Giftiness” score, for each user based on the amount and frequency of the user's contribution, wherein the organization may track, share, and rank the user scores. The organization may also reward and incentivize users based on their user score.

The “text-to-pledge” tool embodied in the systems and methods presented herein provides a complete solution to driving user engagement through the platform. The platform may be provided in part through websites and/or mobile applications specifically developed for corporations, non-profits, churches, government entities, etc.

As described, the pledging tools described herein enable users to pledge time and other non-monetary items in a text based (i.e., SMS based) platform. The SMS platform may be supplemented by or additionally integrated within a broader platform that further enables pledging through web forms, mobile tools, etc.

In addition, the platform may be integrated with social media platforms, such as Facebook and Twitter, both to make pledges (or be taken to the platform to make pledges) through the social media platform and also to share activity and related thoughts through the social media platforms.

Users of the platform may be identified as being associated with any one or more organizations. Accordingly, a user's “Giftiness” score, discussed in greater detail below, may be associated with or tracked within any number of organized groups within the platform. For example, a particular user may have a “Giftiness” score that is associated with a platform associated with the user's business, church, and a non-profit organization for which the user is a volunteer. In some examples, the “Giftiness” score may be different in each of the business, church, and non-profit branded platforms due to scoring weighting factors applied to various activities. For example, some organizations may value certain types of pledges at a greater or lesser value and/or may include or exclude certain types of pledges in the “Giftiness” score.

While existing text-to-pledge applications focus on pledging/collecting money, the systems and methods provided herein also allow for other non-monetary items. This functionality enables the service to be well positioned as a solution for organizations such as non-profits. In this instance, individuals could aid in disaster relief by pledging time, and even specific skills, products, or services to the efforts. For example:
a construction worker could text in a pledge for four hours of carpentry work;
the owner of a local restaurant could pledge 100 sandwiches for volunteer workers; or
a hotel could pledge ten rooms at three nights each for displaced families.

The systems and methods may associate specific points to be awarded to specific non-monetary donations. This enables a comparative running point total to be calculated/provided across a number of non-uniform pledges for a number of users.

Unlike nonprofits' impromptu or seasonal big-ticket pledging events such as disaster relief efforts, annual scholarship luncheons, and holiday galas, corporations have a different set of needs that heavily involves keeping their employees engaged consistently throughout the year. In fact, many companies have entire Employee Engagement teams dedicated to keeping employees not only energized and involved with their own job responsibilities, but also things such as innovation, their communities, health initiatives, and more. Rather than holding a number of one-off volunteer initiatives, companies can utilize the systems and methods provided herein to lay out a slate of opportunities for the quarter or year, and allow employees make pledges towards the categories in which they have some interest. For example, a company's employee engagement calendar may include:
Martin Luther King Jr. Day-On Activities
Student Mentoring Programs
Employee Health & Wellness Weight Loss Challenge
Set Up and Clean Up Responsibilities for the Company Picnic
Community Clean Up Day
United Way Campaign
College Student Job Shadow Day
Fall Festival
Company Holiday Party

Each calendar item may have a sub-menu of specific tasks with “Giftiness” scores attached to them. Employees could pledge their time towards specific events throughout the year, which would then produce a dashboard displaying their potential Giftiness score. As the employees actually fulfill their pledges throughout the year, the employees earn the points, which lead to their end of the year Giftiness Score, which can be used to earn rewards, recognition, etc.

Throughout the year, the platform may display a company-wide Leader Board to show where fellow employees are pledging their time and effort, as well as overall Giftiness score leaders.

As shown, the features and functions provided by the systems and methods described herein enable businesses and organizations to driver user engagement across a variety of pledging opportunities and across a range of time.

The present disclosure provides a system comprising a controller and a memory coupled to the controller, wherein the memory is configured to store program instructions executable by the controller. In response to executing the program instructions, the controller is configured to display a plurality of pledge options including an associated task, wherein each associated task includes an assigned score. The controller is also configured to receive a selection of at least one pledge option, a pledge value associated with the pledge option, and user information from each a plurality of users, and to communicate the pledge option, the pledge value, and the user information to an entity associated with the pledge. In an example, the entity is a third party organization designed to collect payment from the user. Upon confirmation of a user completing the associated task, the controller is configured to generate a user score based on the sum of all the assigned scores of the associated tasks completed by the user. The controller is also configured to provide a dashboard displaying the user score for each of the plurality of users.

In another example, the controller is configured to receive the selected pledge option via a user interface of a mobile device associated with a user, and wherein the controller is configured to extract the user information from the mobile device. Further, the controller may be configured to communicate user demographic information associated with a mobile device associated with the user of the received pledge option to an entity associated with the pledge.

Alternatively, the controller may be configured to receive the selected pledge option and the user information via a user interface of a mobile device associated with a user. For example, the controller may be configured to receive the pledge from a user via text message.

In yet another example, the pledge value includes a pledge currency, wherein the pledge currency is selected from the group consisting of money, time, objects, or combinations thereof.

The controller may be further configured to reward a user when the user score reaches a predetermined score.

The controller may be further configured to store gift matching documentation for requesting a matching gift from an employer, receive access to a social media account associated with a first user, and retrieve employer information associated with the first user. The employer information may be retrieved from the social media account associated with the first user. The controller may further provide the stored gift matching documentation to the first user when the employer information from the social media account associated with the first user matches the employer associated with the stored gift matching documentation. In an example, the gift matching documentation is derived from prior interaction with a second user.

The present disclosure also provides a method of tracking pledge contributions comprising providing a plurality of pledge options including an associated task, wherein each associated task includes an assigned score, receiving a selected pledge option, pledge value, and user information from a user, communicating the pledge option, pledge value, and user information to an entity associated with the selected pledge option, wherein the entity is responsible for retrieving payment information from the user, upon confirmation of a user completing the associated task, generating a user score based on the sum of all the assigned scores of the associated tasks completed by the user, and displaying the user score for each of the plurality users.

In an example, the pledge value includes an associated pledge currency, wherein the pledge currency is selected from the group consisting of money, time, objects, or combinations thereof.

The method may further include storing gift matching documentation for requesting a matching gift from an employer, receiving access to a social media account associated with a first user, and retrieving employer information associated with the first user. In an example, the employer information is retrieved from the social media account associated with the first user. The method may also include providing the stored gift matching documentation to the first user when the employer information from the social media account associated with the first user matches the employer associated with the stored gift matching documentation. In an example, the gift matching documentation is derived from prior interaction with a second user.

An advantage of the present system is receiving pledges via text message, wherein the system lacks a cap on the pledge value, and the pledge value may be in a non-monetary currency, i.e., hours, gifts, goods, service, etc.

Another advantage of the present system is tracking pledge information for an organization or entity associated with the pledge, such that the organization receives user information associated with a received pledge in order to track the demographics of all received pledges.

Another advantage of the present system is incentivizing users to pledge by incorporating a pledge score associated with each user, wherein the pledge score increases with the amount and frequency of pledging by the user.

A further advantage of the present system of tracking pledges is that it is compatible with all wireless providers.

Another advantage of the present system is that an existing merchant organization is responsible for processing payment from the user associated with the received pledge.

Yet another advantage of the present system is that the pledge information may be shared through social media. For example, organizations may create online pledge campaigns to supplement on-site events.

Another advantage of the present system is that it provides users with a convenient donating method via text message without the limitations and wireless fees associated with other fundraising tools.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of an embodiment of the system disclosed herein.

FIGS. 2A and 2B are examples of screenshots of a dashboard including a display of various pledge options with assigned scores.

FIG. 3 is an example of a dashboard including a display of ranked user scores.

FIG. 4 is an example of a dashboard displaying the total contributions, a pledge phone number, the remaining time left for receiving pledges, and the ranked user scores.

### DETAILED DESCRIPTION OF THE INVENTION

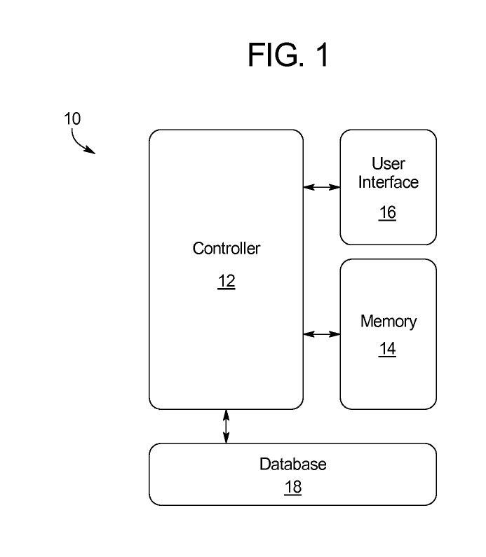

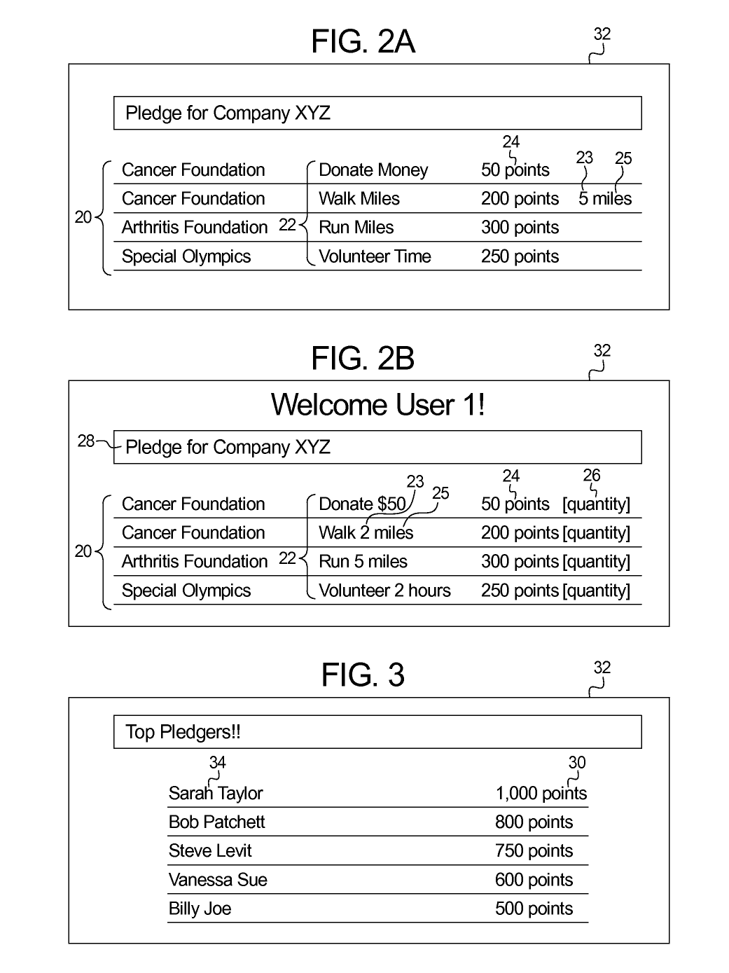

The present disclosure provides a system 10 comprising a controller 12 and a memory 16 coupled to the controller 12, wherein the memory 14 is configured to store program instructions executable by the controller 12, as shown in FIG. 1. In response to executing the program instructions, the controller 12 is configured to display a plurality of pledge options 20 including an associated task 22, wherein each associated task 22 includes an assigned score 24. For example, as shown in FIGS. 2A-2B, the entity 28, Company XYZ, has provided various pledge options 20 associated with the Cancer Foundation, Arthritis Foundation, and Special Olympics, from which a user may select.

As mentioned above, each pledge option 20 has an associated task 22. The associated task 22 may be any type of contribution, including but not limited to, service projects, monetary donations, volunteer time, cans of food, among others. In an example, the associated tasks 22 may be stored in a pledge registry. For example, if an organization is in need of certain items (e.g., clothes, diapers, books, etc.), the items of the associated task 22 may be stored on a registry site for purchasing.

As shown in FIG. 2A the pledge option 20 of the Arthritis Foundation has an associated task 22 of running five miles. In addition, each associated task 22 has an assigned score 24. For example, the associated task 22 of running five miles for the pledge option 20 of the Arthritis Foundation has an assigned score 24 of 300 points. The assigned score 24 may be assigned by the organization or charity foundation. Alternatively, the system 10 may assign the assigned score 24 values by, for example, larger contributions having higher assigned scores 24.

The controller 12 is configured to receive a selection of at least one pledge option 20 and a pledge value 23 associated with the pledge option 20 from each a plurality of users. For example, as shown in FIG. 2A, the user selected the pledge option 20 associated with the Cancer Foundation by submitting a pledge value 23 of five miles. As shown in the example, the pledge value 23 may include a pledge currency 25. In the example, the pledge currency 25 is miles. However, the pledge currency may be any such unit of measurement, including but not limited to, money, time, objects, distance, service, weight, speed, frequency, or combinations thereof.

In another example, as shown in FIG. 2B, the associated task 22 may already include a pledge value 23 and the user may only need to input a quantity value 26 into the quantity text box. For example, the user may select a quantity value 26 of two, which indicates the user is pledging the associated task 22 twice, and upon completion the user earns twice the amount of the assigned score 24.

The controller 12 is also configured to receive user information 34. The user information 34 may include the name of the account holder, an account number associated with the user, user demographic information, or combinations thereof. For example, the user demographic information may include the age, address, gender, salary information, and preference information. For example, preference information may include the type of associated task 22 the user prefers, perhaps based on prior received pledging options 20 from the user or from preferences specified by the user.

The pledge option 20, the pledge value 23, and the user information 34 may be communicated to an entity 28 associated with the pledge option 20. For example, the pledge option 20, the pledge value 23, and the user information 34 may be communicated to the entity 28, Company XYZ, in order for the entity 28 to track and analyze its received pledge options 20. Alternatively, or in addition to, the pledge value 23 and the user information 34 may be communicated to an entity 28 associated with completing payment or collecting pledge funds. As such, the system 10 incorporates a fund collection mechanism that eliminates the limitations caused by the monetary caps placed on donations that are billed through mobile phone service providers.

In another example, the system 10 may be integrated with a user's bank account, such that upon submitting a monetary pledge, the controller 12 via a bill pay integration program collects the associated funds from the user's bank account. Further, upon receiving a pledge option 20 from the user, the controller 12 may initiate subsequent steps to complete the transaction. For example, the controller 12 may communicate with the mobile device associated with the user in order to request payment information. The controller 12 may send payment forms to the user, schedule automatic payments, send a thank you communication to the user, send a reminder email to the user, and/or report the user's balance to the user.

In addition to the pledge value 23, the user may enter the user information 34 via the user interface 16. For example, the user may text the pledge value 23 and user information 34 (e.g., user name) to a pledge phone number 36 provided by the entity 28. Alternatively, user information 34 may be automatically obtained by the controller 12 based on a mobile device associated with the user. For example, the user information 34 may include the user phone number, which may be automatically acquired by the system 10 upon a user texting the pledge value 23. The user information 34 may also be acquired by accessing a social network platform associated with the user, which is discussed more below.

Upon confirmation of a user completing the associated task 22, the controller 12 is configured to generate a user score 30 based on the sum of all the assigned scores 24 of the associated tasks 22 completed by the user. For example, if the user has a preexisting user score 30 of 500 points and the user completed an associated task 22 having an assigned score 24 of 50 points, then the controller 12 generates a user score 30 of 550 points. Of course other calculations of the user score 30 are contemplated. In an example, the controller 12 takes into account the frequency at which a user contributes when generating the user score 30, such that higher frequency contributions may be awarded additional points.

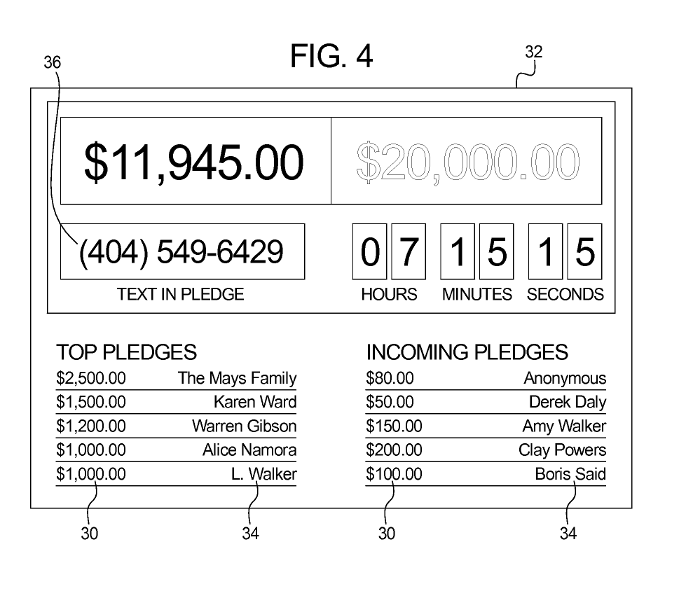

The controller 12 is also configured to provide a dashboard 32 that displays the user score 30 for each of the plurality of users. As shown in FIG. 4, the various user information 34, indicated by the user's name, are ranked according to their user score 30. The controller may display a dashboard 32 associated with each user account. For example, a user may view their own contribution page where the dashboard 32 includes a display of the user's history of completed associated tasks 22 and the user score 30.

The system 10 is also configured to reward a user when the user score 30 reaches a predetermined value or amount. For example, the organization may have pledge rules set in place that state once a user pledges five hundred dollars the user may receive a reward, such as extra points that are added to the user score 30, a gift, and/or prize, among others.

The controller 12 may be configured to access information from a social network associated with a user, if the user grants the controller 12 permission to access the user's account within the social network platform. Upon being granted access to a user's social network information, the system 10 may obtain user information 34 from, for example, a user's profile information of the social network. The user information 34 obtained from the social network may be used for a plethora of reasons, including received pledge analysis by the organization. For example, the user information 34 obtained from the social network may include employment information or user demographic information, which the organization may use when analyzing what employment sector, age group, or gender, for example, contributes the most or least pledge contributions. The user information 34 may be used to benefit the user as well. For example, the system 10 may extract a portion of the user information 30 from the social network information instead of the system 10 requiring the user information 34 to be entered manually by the user. Of course, it should be understood that the controller 12 may be configured to access user information from various sources including, but not limited to, internal databases, company websites, and other external sources.

In another example, user information 34 obtained from a social network platform may be used to expedite a paperwork process established with an employer gift-matching program. For example, the system 10 may include the capability of providing documents associated with an employer's gift-matching program based on received user information 34. In an example, the controller 12 may be configured to store gift-matching documentation for requesting a matching gift from an employer. The controller 12 may be further comprised to receive access to a social media account associated with a first user and retrieve employer information from the social media account associated with the first user. Further, the controller 12 may be configured to provide the stored gift-matching documentation to the first user when the employer information from the social media account associated with the first user matches the employer associated with the stored gift-matching documentation.

In other words, if based on the user information 34 of a first user, the controller 12 determines that the first user is employed at Company XYZ, the controller 12 may then search the database 18 for documentation associated with Company XYZ's employer gift-matching documentation. If the corresponding documentation is found, then the controller 12 provides the first user with the stored gift-matching documentation.

In addition, the gift-matching documentation may be derived from prior interaction with a second user. For example, the stored gift-matching documentation may have originally been collected and stored based on a previous interaction with a second user. For example, suppose a second user was employed at Company XYZ and initially either obtained the documentation from the Company XYZ or the Company XYZ provided the documentation to the controller 12. The controller 12 then stores the gift-matching documentation associated with Company XYZ and provides the documentation when, for example, the employment information from a social media account associated with a first user (subsequent in time to the second user) matches that of Company XYZ. In other words, user information 32 obtained from a social media network may be used to the advantage of subsequent users, making the system and process more efficient.

The controller 12 may be configured to analyze the received pledge options 20, assigned score 24, and/or user scores 30. For example, the system 10 may produce various graphs and other visual representations to aid an organization in understanding a plethora of variables related to its received pledges. The system 10 may produce a graph that provides an organization a visual representation of particular user information 34 (e.g., gender and average income) associated with the received pledge options 20 and/or pledge values 26.

FIG. 4 presents another example of an embodiment of a dashboard 32 associated with the system 10. As shown, an organization may have a dashboard 32 that displays the top ranked user scores 30. In the example in FIG. 4, the user information 34 is the user's name, and the user score 30 is the total monetary contribution associated with the user's pledges. The dashboard 32 displayed in FIG. 4 has the ranked user scores 30 associated with the top pledges and also the incoming pledges. Also displayed is the total monetary contributions of $11,945.00 as well as a pledge telephone number 36 that users may call or text to pledge a pledge value 23. Although, it should be understood that the pledge telephone number 36 could be any form of contact with the system 10. For example, instead of the pledge phone number 36, the dashboard may provide a hashtag, user name, social media contact information, etc.

The present disclosure also provides a method of tracking pledge contributions comprising providing a plurality of pledge options 20 including an associated task 22, wherein each associated task 22 includes an assigned score 24, receiving a selected pledge option 20, pledge value 23, and user information 34 from a user, communicating the pledge option 20, pledge value 23, and user information 34 to an entity associated with the selected pledge option 20, wherein the entity is responsible for retrieving payment information from the use. Upon confirmation of a user completing the associated task 22, the method includes generating a user score 30 based on the sum of all the assigned scores 24 of the associated tasks 22 completed by the user, and displaying the user score 30 for each of the plurality users.

The system 10 may also store documents needed to set up a charity platform and/or individual pledge options 20. For example, the system 10 may store documents associated with an entity, such that if another organization wishes to set up a charity associated with the entity, the paperwork may be easily provided to the appropriate organization.

The system 10 may include a one-click, real-time establishment of a contribution platform for an organization. The click of a button may provide a pledge phone number 36 that initiates a pledging campaign once the pledge phone number 36 is shared with the public.

The system 10 may also include a location device (e.g., GPS) such that when a mobile device associated with the user is within a certain proximity to a place (e.g., a store, restaurant, charity event, etc.), the controller 12 may alert the user of pledging campaigns that are associated with the user's location. For example, if the user is near a restaurant that was donating a portion of its earnings to a certain charity, the controller 12 may alert the user of the event. If the user proceeds to dine at the restaurant or donate to the cause, then the controller 12 may then update the user's score 30. In addition, certain locations, such as a store front, may include a touch screen dashboard 32 that displays the various pledging options 20 available to users. Users may also be notified of pledging options 20 through advertisements and notifications on webpages, through TV service providers, etc. Further, a smart TV may display a dashboard 32 as disclosed herein.

As mentioned above and schematically shown in FIG. 1, aspects of the systems and methods described herein are controlled by one or more controllers 12. The one or more controllers 12 may be adapted to run a variety of application programs, access and store data, including accessing and storing data in the associated databases 18, and enable one or more interactions as described herein. Typically, the controller 12 is implemented by one or more programmable data processing devices. The hardware elements, operating systems, and programming languages of such devices are conventional in nature, and it is presumed that those skilled in the art are adequately familiar therewith.

For example, the one or more controllers 12 may be a PC based implementation of a central control processing system utilizing a central processing unit (CPU), memory 14 and an interconnect bus. The CPU may contain a single microprocessor, or it may contain a plurality of microprocessors for configuring the CPU as a multi-processor system. The memory 14 may include a main memory, such as a dynamic random access memory (DRAM) and cache, as well as a read only memory, such as a PROM, EPROM, FLASH-EPROM, or the like. The system may also include any form of volatile or non-volatile memory 14. In operation, the memory 14 stores at least portions of instructions for execution by the CPU and data for processing in accord with the executed instructions.

The one or more controllers 12 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 12 may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces 16 for the controller 12. For example, the one or more controllers 12 may include a graphics subsystem to drive the output mechanism. The links of the peripherals to the system may be wired connections or use wireless communications.

Although summarized above as a PC-type implementation, those skilled in the art will recognize that the one or more controllers 12 also encompasses systems such as host computers, servers, workstations, network terminals, and the like. Further one or more controllers 12 may be embodied in a device, such as a mobile electronic device, like a smartphone or tablet computer. In fact, the use of the term controller 12 is intended to represent a broad category of components that are well known in the art.

Hence aspects of the systems and methods provided herein encompass hardware and software for controlling the relevant functions. Software may take the form of code or executable instructions for causing a controller 12 or other programmable equipment to perform the relevant steps, where the code or instructions are carried by or otherwise embodied in a medium readable by the controller 12 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory 14 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller 12 can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method and portable electronic device may be provided based on various combinations of the features and functions from the subject matter provided herein.

We claim:

1. A system comprising:
a controller;
a memory coupled to the controller, wherein the memory is configured to store program instructions executable by the controller;
wherein in response to executing the program instructions, the controller is configured to:
display a plurality of pledge options including an associated task, wherein each associated task includes an assigned score;
receive a selection of at least one pledge option, a pledge value associated with the pledge option, and user information from each a plurality of users;
communicate the pledge option, the pledge value, and the user information to an entity associated with the pledge;
upon confirmation of a user completing the associated task, generate a user score based on the sum of all the assigned scores of the associated tasks completed by the user; and
provide a dashboard displaying the user score for each of the plurality of users.

2. The system of claim 1 wherein the controller is configured to receive the selected pledge option via a user interface of a mobile device associated with a user, and wherein the controller is configured to extract the user information from the mobile device.

3. The system of claim 1 wherein the controller is configured to communicate user demographic information associated with a mobile device associated with the user of the received pledge option to an entity associated with the pledge option.

4. The system of claim 1 wherein the controller is configured to receive the selected pledge option and the user information via a user interface of a mobile device associated with a user.

5. The system of claim 1 wherein the controller is configured to receive the pledge value from a user via text message.

6. The system of claim 1 wherein the pledge value includes a pledge currency, wherein the pledge currency is selected from the group consisting of money, time, objects, or combinations thereof.

7. The system of claim 1 wherein the controller is further configured to reward a user when the user score reaches a predetermined score.

8. The system of claim 1 wherein the controller is further configured to:
store gift matching documentation for requesting a matching gift from an employer;
receive access to a social media account associated with a first user;
retrieve employer information from the social media account associated with the first user;
provide the stored gift matching documentation to the first user when the employer information from the social media account associated with the first user matches the employer associated with the stored gift matching documentation.

9. The system of claim 1 wherein the gift matching documentation is derived from prior interaction with a second user.

10. The system of claim 1 wherein the entity is a third party organization designed to collect payment from the user.

11. A method of tracking pledge contributions comprising:
providing a plurality of pledge options including an associated task, wherein each associated task includes an assigned score;
receiving a selected pledge option, pledge value, and user information from a user;
communicating the pledge option, pledge value, and user information to an entity associated with the selected pledge option, wherein the entity is responsible for retrieving payment information from the user;
upon confirmation of a user completing the associated task, generating a user score based on the sum of all the assigned scores of the associated tasks completed by the user; and
displaying the user score for each of the plurality users.

12. The method of claim 11 wherein the pledge value includes an associated pledge currency, wherein the pledge currency is selected from the group consisting of money, time, objects, or combinations thereof.

13. The method of claim 11 further comprising:
storing gift matching documentation for requesting a matching gift from an employer;
receiving access to a social media account associated with a first user;
retrieving employer information associated with the first user; and
providing the stored gift matching documentation to the first user when the employer information from the social media account associated with the first user matches the employer associated with the stored gift matching documentation.

14. The method of claim 13 wherein the gift matching documentation is derived from prior interaction with a second user.

15. The method of claim 13 wherein the employer information associated with the first user is obtained from the user's social media account.
